(19) United States
(12) Patent Application Publication
(10) Pub. No.: US 2011/0077954 A1
(43) Pub. Date: Mar. 31, 2011

(54) THERAPY RECONCILIATION FOR VENUE TRANSITION

(75) Inventors: CHARLES FREDERICK SCHNEIDER, TRIMBLE, MO (US); BRITTON K. JENNINGS, SMITHVILLE, MO (US); ELIZABETH JEAN PARMAN, KANSAS CITY, MO (US); LEI HAN, OVERLAND PARK, KS (US); CAROL ANN MARTIN, KANSAS CITY, MO (US)

(73) Assignee: CERNER INNOVATION, INC., OVERLAND PARK, KS (US)

(21) Appl. No.: 12/567,211

(22) Filed: Sep. 25, 2009

(51) Int. Cl. G06Q 50/00

(52) U.S. Cl. 705/2

(57) ABSTRACT

The present invention is directed to selecting a therapy designation that is usable to identify a therapy when the therapy is implemented in a treatment venue. A therapy designation is received that identifies the therapy (e.g., administration of a medication) when the therapy is administered in a first treatment venue. Alternative therapy designations are referenced that are usable to identify the therapy when the therapy is implemented in a second treatment venue. An equivalent therapy designation is selected that, based on one or more rules, is most similar to the first therapy designation.

### BACKGROUND

Often, an individual is following a therapy regimen when the individual transitions from one treatment venue (e.g., outpatient environment) to a subsequent treatment venue (e.g., inpatient facility). At the time of the transition, determinations are typically made as to whether the individual should continue with the therapy regimen that he or she was following. In those situations in which the individual will continue to follow the therapy regimen, it is time-consuming to recreate new orders or prescriptions that are used in the subsequent treatment venue. As such, technology that converts the order or prescription to be used in the subsequent treatment venue would be useful. However, even though the same therapy regimen might be available in the subsequent treatment venue, often times the subsequent treatment venue uses an alternative therapy designation to identify the therapy regimen. These alternative therapy designations can create issues when determining how to write a prescription or order for the therapy in the subsequent treatment venue. As such, it becomes necessary to identify the best of the alternative designations to accurately identify the therapy regimen. Technology that helps to identify the best of the alternative designations would be useful.

### SUMMARY

Embodiments of the invention are defined by the claims below, not this summary. A high-level overview of various aspects of the invention are provided here for that reason, to provide an overview of the disclosure and to introduce a selection of concepts that are further described below in the detailed-description section. This summary is not intended to identify key features or essential features of the claimed subject matter, nor is it intended to be used as an aid in isolation to determine the scope of the claimed subject matter.

The present invention is directed to selecting a therapy designation that is usable to identify a therapy when the therapy is implemented in a treatment venue. An exemplary embodiment of the present invention includes receiving a first therapy designation that identifies the therapy when the therapy is implemented in a first treatment venue. Alternative therapy designations are referenced that are usable to identify the therapy when the therapy is implemented in a second treatment venue. An equivalent therapy designation is selected that, based on one or more rules, is most similar to the first therapy designation. The equivalent therapy designation is presented to be used to identify the therapy in the second treatment venue.

Another exemplary embodiment includes a receiving component that is usable to receive a first therapy designation, which identifies the therapy when the therapy is implemented in a first treatment venue. A therapy reconciler references alternative therapy designations that are usable to identify the therapy when the therapy is implemented in a second treatment venue. A rules engine provides the therapy reconciler with rules, which are usable to select from the alternative therapy designations an equivalent therapy designation that is similar to the first therapy designation. A presentation component presents the equivalent therapy designation to be used to identify the therapy in the second treatment venue.

### BRIEF DESCRIPTION OF THE SEVERAL VIEWS OF THE DRAWINGS

Illustrative embodiments of the present invention are described in detail below with reference to the attached drawing figures, wherein:

FIG. 1 is a block diagram of an exemplary computing environment suitable for use in implementing embodiments of the present invention;

FIG. 2 is an exemplary system architecture suitable to implement embodiments of the present invention;

FIGS. 3-9 depict illustrative screenshots pursuant to embodiments of the present invention; and

FIG. 10 is a flow diagram of a method in accordance with an embodiment of the present invention.

### DETAILED DESCRIPTION

The subject matter of embodiments of the present invention is described with specificity herein to meet statutory requirements. But the description itself is not intended to necessarily limit the scope of claims. Rather, the claimed subject matter might be embodied in other ways to include different components and different steps or combinations of steps similar to the ones described in this document, in conjunction with other present or future technologies. Terms should not be interpreted as implying any particular order among or between various steps herein disclosed unless and except when the order of individual steps is explicitly stated.

An embodiment of the present invention is directed to selecting a therapy designation that is usable to identify a therapy (e.g., administration of a medication) when the therapy is implemented in a treatment venue. For example, a first therapy designation is received that identifies the therapy when the therapy is implemented in a first treatment venue (e.g., inpatient facility). Alternative therapy designations are referenced that are usable to identify the therapy when the therapy is implemented in a second treatment venue (e.g., outpatient environment). An equivalent therapy designation is selected that, based on one or more rules, is most similar to the first therapy designation. The equivalent therapy designation is presented to be used to identify the therapy in the second treatment venue.

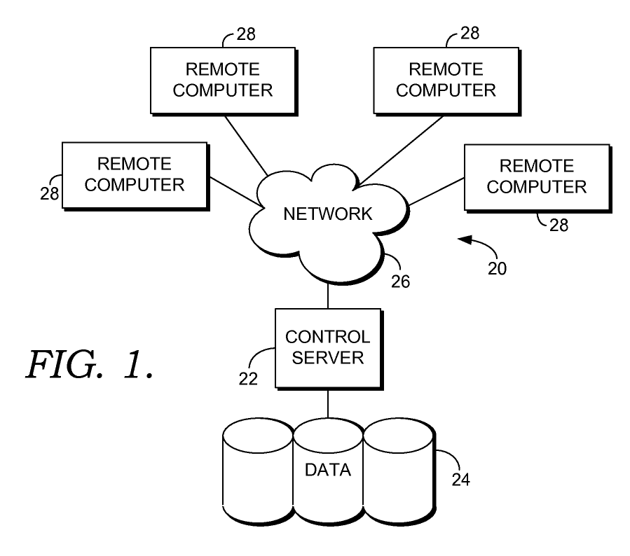

Having briefly described embodiments of the present invention, an exemplary operating environment suitable for use in implementing embodiments of the present invention is described below. Referring to FIG. 1 an exemplary computing environment (e.g., medical-information computing-system environment) with which embodiments of the present invention may be implemented is illustrated and designated generally as reference numeral 20. The computing environment 20 is merely an example of one suitable computing environment and is not intended to suggest any limitation as to the scope of use or functionality of the invention. Neither should the computing environment 20 be interpreted as having any dependency or requirement relating to any single component or combination of components illustrated therein.

The present invention might be operational with numerous other general purpose or special purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules include routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 20 includes a general purpose computing device in the form of a control server 22. Exemplary components of the control server 22 include a processing unit, internal system memory, and a suitable system bus for coupling various system components, including database cluster 24, with the control server 22. The system bus might be any of several types of bus structures, including a memory bus or memory controller, a peripheral bus, and a local bus, using any of a variety of bus architectures. Exemplary architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 22 typically includes therein, or has access to, a variety of computer-readable media, for instance, database cluster 24. Computer-readable media can be any available media that might be accessed by server 22, and includes volatile and nonvolatile media, as well as, removable and nonremovable media. Computer-readable media might include computer storage media. Computer storage media might include volatile and nonvolatile media, as well as, removable and nonremovable media implemented in any method or technology for storage of information, such as computer-readable instructions, data structures, program modules, or other data. In this regard, computer storage media might include RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 22. Combinations of any of the above also may be included within the scope of computer-readable media.

The computer storage media discussed above and illustrated in FIG. 1, including database cluster 24, provide storage of computer-readable instructions, data structures, program modules, and other data for the control server 22.

The control server 22 might operate in a computer network 26 using logical connections to one or more remote computers 28. Remote computers 28 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians might include a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 28 might also be physically located in nontraditional medical care environments so that the entire healthcare community might be capable of integration on the network. The remote computers 28 might be personal computers, servers, routers, network PCs, peer devices, other common network nodes, or the like; and might include some or all of the elements described above in relation to the control server 22. The devices can be personal digital assistants or other like devices.

Exemplary computer networks 26 include local area networks (LANs) and/or wide area networks (WANs). Such networking environments are commonplace in offices, enterprise-wide computer networks, intranets, and the Internet. When utilized in a WAN networking environment, the control server 22 might include a modem or other means for establishing communications over the WAN, such as the Internet. In a networked environment, program modules or portions thereof might be stored in association with the control server 22, the database cluster 24, or any of the remote computers 28. For example, various application programs may reside on the memory associated with any one or more of the remote computers 28. It will be appreciated by those of ordinary skill in the art that the network connections shown are exemplary and other means of establishing a communications link between the computers (e.g., control server 22 and remote computers 28) might be utilized.

In operation, a clinician might enter commands and information into the control server 22 or convey the commands and information to the control server 22 via one or more of the remote computers 28 through input devices, such as a keyboard, a pointing device (commonly referred to as a mouse), a trackball, or a touch pad. Other input devices include microphones, satellite dishes, scanners, or the like. Commands and information might also be sent directly from a remote healthcare device to the control server 22. In addition to a monitor, the control server 22 and/or remote computers 28 might include other peripheral output devices, such as speakers and a printer.

Although many other internal components of the control server 22 and the remote computers 28 are not shown, those of ordinary skill in the art will appreciate that such components and their interconnection are well known. Accordingly, additional details concerning the internal construction of the control server 22 and the remote computers 28 are not further disclosed herein.

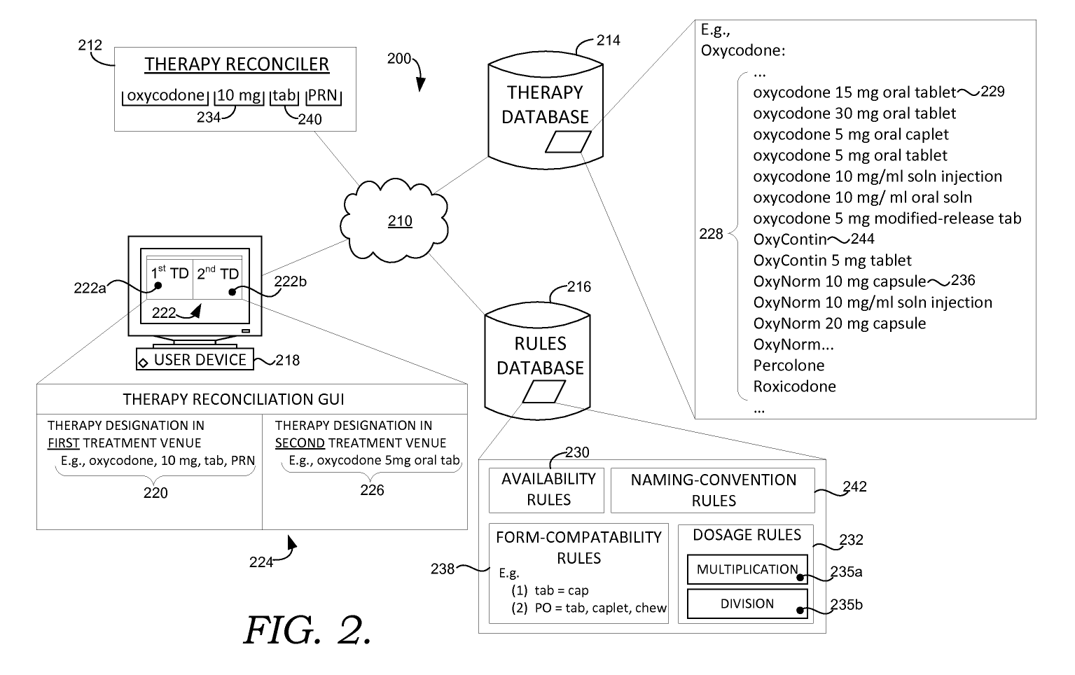

Turning now to FIG. 2, a schematic diagram depicts an operating environment, identified generally by reference numeral 200, that is suitable to practice embodiments of the present invention. FIG. 2 includes various components that communicate with one another by way of a network 210. For example, a therapy reconciler 212, a therapy database 214, a rules database 216, and a user device 218 all communicate by way of the network 210. Although these components are shown separately, two or more of the components might be combined into a single component. Moreover, although only one of each component is shown, in some embodiments, each component might include a plurality of components. Furthermore, in other embodiments, the operating environment 200 includes additional components that operate together with the network 210 and the components 212, 214, 216, and 218.

In an exemplary embodiment of the present invention, the user device 218 is operable to receive an input of a therapy designation. As used herein, “therapy designation” describes one or more terms that describe a specific therapy. For example, to describe a specific therapy that includes administration of a medication, a therapy designation might be used that includes the name of the medication and a dosage that is to be administered. Other therapy designations might also include a product strength, a number of medication units, a medication form (e.g., tablet, caplet, capsule, etc.), form special characteristics (e.g., extended release), route of administration, frequency of administration, and brand information. For example, to describe a specific therapy that includes administration of 500 mg of aspirin, a therapy designation might include “‘aspirin 250 mg,’ 500 mg, 2 tab,” which indicates administration of 2 tabs aspirin, each of which includes a strength of 250 milligrams, to achieve a dose of 500 mg. In embodiments of the present invention, therapy designations are often included as part of a prescription or an order that is created by a healthcare professional to treat a patient. FIG. 2 depicts exemplary therapy designation 220, which describes a therapy when the therapy is administered in a first treatment venue. FIG. 2 also depicts exemplary therapy designation 226, which describes the therapy when the therapy is administered in a second treatment venue. As used herein “treatment venue” describes a location and/or an environment in which a therapy is administered to an individual. Examples of treatment venues include a hospital, a doctor's office, a pharmacy, an inpatient healthcare facility, and an outpatient healthcare facility. As used herein, “therapy” includes any form of treatment for any problem, diagnosis, illness, or disorder. Examples of therapies include prescription medications, over-the-counter medications, physical therapy treatment, occupational therapy treatment, respiratory therapy treatment, speech therapy treatment, and the like. In embodiments described herein, a first treatment venue represents a treatment venue from which a patient is transitioning, and a second treatment venue represents a treatment venue to which a patient is transitioning. For example, if a patient is being admitted from the outpatient care of a general physician into a hospital, the outpatient environment is the first treatment venue and the hospital is the second treatment venue. In FIG. 2, reference numeral 222a generally describes a therapy designation that is used to identify a therapy in a first treatment venue and reference numeral 222b generally describes the therapy that is used to identify a therapy in a second treatment venue.

In embodiments of the present invention, the user device 218 receives input of therapy designations 222a by a variety of means, which might depend on whether the therapy designation identifies a therapy in either a first treatment venue or a second treatment venue. For example, FIG. 2 depicts therapy designation 220, which describes a therapy in a first treatment venue. A user might manually input the therapy designation 220 into the user device 218, such as by using a keyboard or other input device. Alternatively, a user might use the user device 218 to retrieve the therapy designation 220 from an electronic record or database (e.g., electronic medical record of a patient). FIG. 2 also depicts the therapy designation 226, which describes the therapy in a second treatment venue. In embodiments of the present invention the therapy designation 226 is received from another component of the computing environment 200. For example, components of the computing environment, such as the therapy reconciler 212, might have determined that the therapy designation 226 was an equivalent therapy designation of the therapy designation 220 and communicated the therapy designation 226 to the user device 218.

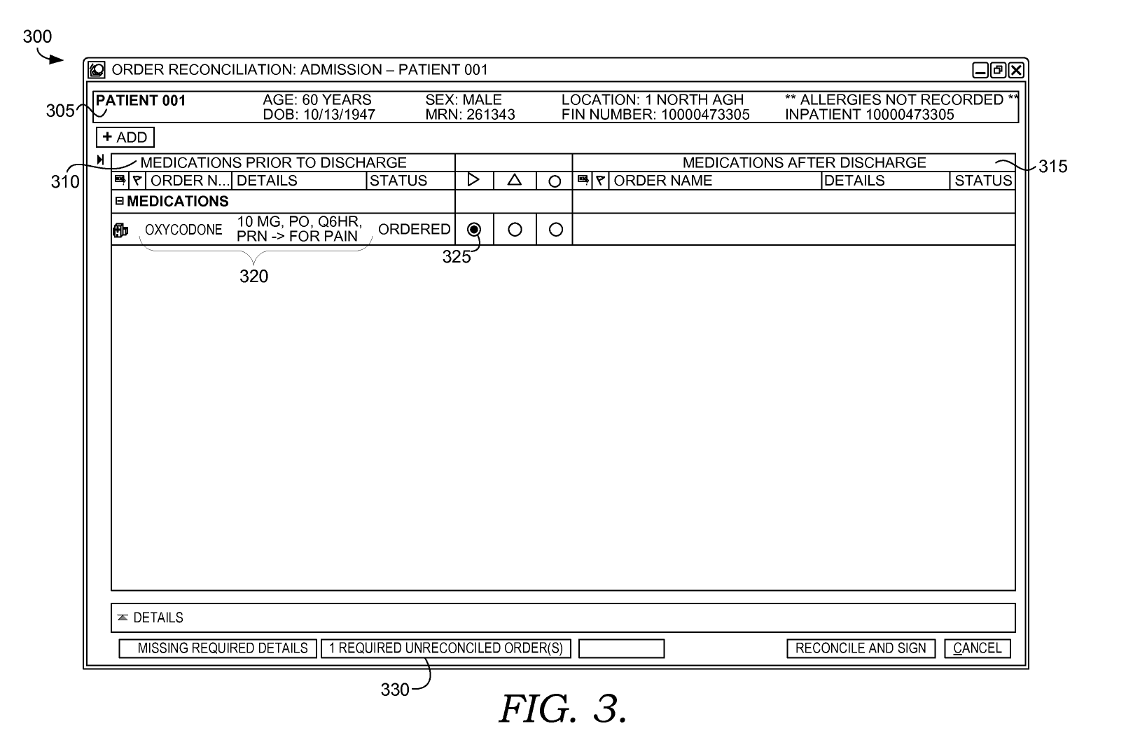

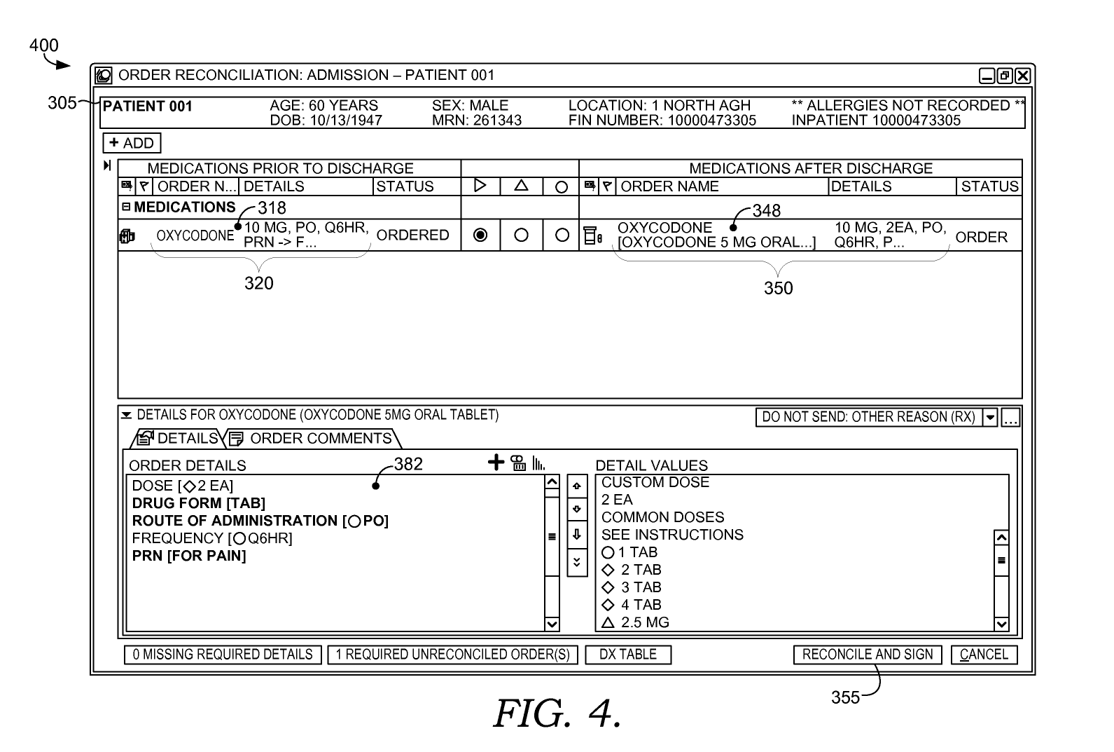

In a further embodiment the user device 218 includes a graphical user interface 222 (hereinafter “GUI”) that facilitates input of a therapy designation 222a into the user device 218. An exploded view 224 of a screenshot of the GUI 222 is depicted in FIG. 2. (Additional exemplary screenshots of the GUI 222 are depicted in FIGS. 3-9 and will be described in more detail below.) In one embodiment, the GUI includes a medication-input portion that allows a user to input a first therapy designation. For example, portion 318 in FIG. 4 allows a user to input a first therapy designation. In a further embodiment, the GUI includes a therapy-reconciliation-results portion that is usable to display an equivalent therapy designation, which is selected based on a set of rules. For example, portion 348 in FIG. 4 displays an equivalent therapy designation. In another embodiment, the GUI includes a details-entry portion that allows a user to input instructions that describe administration of the equivalent therapy designation. For example, portion 382 in FIG. 4 allows a user to input instructions.

The user device 218 might receive an input of a therapy designation 222a at various times in connection with the treatment of a patient and with the transition of a patient from one treatment venue to another treatment venue. For example, the user device 218 might receive an input of the therapy designation 222a as part of a process of admitting a patient into a healthcare facility. Alternatively, the user device 218 might receive an input of the therapy designation 222a in connection with a discharge of a patient from a healthcare facility.

In embodiments of the present invention, the therapy reconciler 212 communicates with the user device 218, such as via the network 210. For example, the therapy reconciler 212 might include one or more of the computing devices that were described together with FIG. 1, such as the control server 12. Alternatively, the therapy reconciler 212 might be combined together with the user device 218 in a single computing device, such that the therapy reconciler 212 is a component of the user device 218 or the user device 218 is a component of the therapy reconciler 212.

The therapy reconciler 212 is operable to receive a therapy designation and select an equivalent therapy designation to describe the therapy. For example, a user might input the therapy designation 220 into the user device 218 and determine that the patient should continue to receive (in the second treatment venue) the therapy that is described by the therapy designation 220. Upon submission of the therapy designation 220 to the therapy reconciler 212, the therapy reconciler 212 applies rules from the rules database 216 to possible alternative therapy designations stored in the therapy database 214 to select an equivalent therapy designation.

The therapy database 214 stores therapy designations, each of which is used to describe a respective therapy in a subsequent treatment venue. In embodiments of the present invention, the subsequent treatment venue includes a treatment venue into which a patient is transitioning. For example, if a patient is being admitted to an inpatient healthcare facility, the inpatient healthcare facility is the subsequent treatment venue and the therapy database 214 stores therapy designations that are used by the inpatient healthcare facility for order and/or prescription purposes. In another embodiment, if a patient is being discharged from an inpatient healthcare facility, an independent pharmacy (i.e., not a part of the inpatient healthcare facility) might be the subsequent treatment venue and the therapy database 214 stores therapy designations that are used by the pharmacy for prescription purposes. In FIG. 2 the therapy designation 220 that is input indicates “oxycodone, 10 mg, tab, PRN,” which describes administration of oxycodone per dosage, form, and frequency specifications. The therapy database 214 stores therapy designations 228 that describe oxycodone-related therapies that are available in the second treatment venue. Each of the therapy designations 228 describes a therapy together with administration-related information. For example, therapy designation 229 specifies the medication “oxycodone” in a 15 mg tablet that is taken orally. In an embodiment of the present invention, by applying rules from the rules database 216, the therapy reconciler 212 selects from the therapy designations 228 an equivalent designation that is usable as an alternative to the therapy designation 220.

In further embodiments of the present invention, an amount of detail included in therapy designations that are stored in therapy database 214 will vary depending on the subsequent treatment venue to which a patient is transitioning. Treatment venues that operate with an inventory that is not predictable might use therapy designations that include fewer details. For example, a “Treatment Venue A” might always have available “Drug X”; however, the strength of the version of Drug X that is carried might change on a regular basis. That is, one month, Treatment Venue A might carry 500 mg caplets of Drug X and the next month might carry 300 mg tablets of Drug X. As such, Treatment Venue A might not include in the therapy database 214 a therapy designation that specifies either a 500 mg caplet or a 300 mg tablet and instead might only include in the therapy database 214 a therapy designation that specifies “Drug X.” On the other hand, treatment venues that operate with a predictable inventory might use therapy designations that include more details. For example, a “Treatment Venue B” might always have available “Drug Y 500 mg caplets” and “Drug Y 300 mg tablets.” As such, Treatment Venue B might include in the therapy database 214 both therapy designations (i.e., Drug Y 500 mg caplets and Drug Y 300 mg tablets) that specify a strength of the drug that is available.

The rules database 216 includes a set of rules that are usable to select from the therapy designations 228 an equivalent therapy designation. As used herein “equivalent therapy designation” refers to a therapy designation in the therapy database 214 that is, based on a set of rules, most similar to a therapy designation that was input, such as therapy designation 220. For example, if the therapy designation 220 was input as a treatment in a first treatment venue, the description that is most similar would be “oxycodone, 10 mg, tab, PRN,” (i.e., the exact same description is the most similar). However, as is often the case, therapy database 214 does not include a therapy designation that exactly matches “oxycodone, 10 mg, tab, PRN” because the therapy is not available to be ordered or prescribed in that exact manner in the second treatment venue. Instead, only the therapy designations 228 that are listed are available as possible therapy designations. As such, the rules of rules database 216 are applied to the therapy designations 228 to identify an equivalent therapy designation, which is most similar to the therapy designation 220.

In embodiments of the present invention, the rules of the rules database 216 are usable to identify: an equivalent therapy designation; alternative therapy designations that, although not most similar, are still acceptable to describe the therapy; and alternative therapy designations that are not acceptable to describe the therapy. For example, a therapy designation in a first treatment venue might include “acetaminophen, 350 mg, tab” and alternative therapy designations in a second treatment venue might include “acetaminophen, 350 mg, caplet,” “acetaminophen, 700 mg, tab,” and “acetaminophen combo, 700 mg, capsule.” In this case, the rules (described in more detail below) might dictate: a caplet is an acceptable alternative to a tablet; division by one-half is acceptable; whole numbers of medication units are favored; and capsules are not acceptable alternatives to tablets. As such, because a caplet is an acceptable alternative to a tablet and whole numbers are favored, “acetaminophen, 350 mg, cap” is the most similar to “acetaminophen, 350 mg, tab” based on the rules. Furthermore, because a 700 mg tablet can be divided in one-half to yield 350 mg, “acetaminophen, 700 mg, tab” is an acceptable alternative, although it might not be the most similar. Moreover, because capsules are not acceptable alternatives to tablets and because “acetaminophen combo” is a different drug than “acetaminophen,” “acetaminophen, 700 mg, capsule” is not an acceptable alternative therapy designation to describe the therapy. Accordingly, embodiments of the present invention identify, from a listing of therapy designations, a best match (i.e., equivalent); matches (i.e., acceptable alternative but not the best), and nonmatches (i.e., not an acceptable alternative to describe the therapy).

In one embodiment, the rules database 216 includes an availability rule 230, which is usable to select an equivalent therapy designation based on availability of a therapy in a version that is specifically described by a first therapy designation (e.g., the therapy designation 220). As such, upon receiving a therapy designation, the therapy reconciler 212 applies the availability rule 230 to therapy designations stored in the therapy database 214, to determine if any of the therapy designations include the version of the therapy that is specified by the therapy designation (i.e., that is the same as the therapy designation). For example, the therapy designation 220 specifies a version of a therapy, which includes administration of 10 mg of oxycodone by tablet as needed. Accordingly, upon receiving the therapy designation 220, the therapy reconciler 212 evaluates the therapy designations 228 to determine if any of them match therapy designation 220 (i.e., to determine if the second treatment venue has available the version of the therapy that is specified by therapy designation 220). In the example provided by FIG. 2, none of the therapy designations 228 include the version of the therapy that is specified by therapy designation 220, so the availability rule 230 is not met. In an embodiment of the present invention, if the availability rule 230 is not met, other rules (described in more detail below) are applied to the therapy designations to determine if an acceptable match might still be found. However, if the availability rule is met, the therapy designation that matches the therapy designation in the first treatment venue is communicated to the user device 218. In these circumstances, when the availability rule is met, both the therapy designation in the first treatment venue and the therapy designation in the second treatment venue will include the same description of the therapy.

In a further embodiment, the rules database 216 includes dosage rules 232, which are usable to select an equivalent therapy designation based on dosage-achievability considerations. Dosage-achievability considerations include an ability of a strength that is specified by a therapy designation, which is stored in the therapy database 214, to achieve a dosage that is specified by a therapy designation in a first treatment venue (e.g., therapy designation 220). In one embodiment, if the availability rules 230 (described previously) are not met, the therapy reconciler 212 extracts any dosage and strength information (e.g., total dose, a strength, a volume, or a free text dose unit) that might be included in the therapy designation that is used to identify the therapy in the first treatment venue. For example, dosage and strength information might include only an indication of the strength of a medication unit, in which it is often the case that only one medication unit is administered and the dose and the strength have the same value. Alternatively, both a dosage value and a strength value might be included, in which case a number of medication units (e.g., 2 tabs) that are administered dictates how the dosage (e.g., 600 mg) is achieved using the strength (e.g, Drug Z 300 mg tab) that is indicated. Furthermore, only a dosage might be specified (e.g., therapy designation 220), such that the strength of the medication unit and the number of medication units are dictated by the product selected to administer the therapy. In an embodiment of the present invention, the original number of medication units (e.g., pills) is favored over a multiplication or a division of the original number of medication units, provided that other rules are satisfied. As such, the dose and strength information that was extracted is compared to the therapy designations (e.g., therapy designations 228) stored in the therapy database 214 to search for an exact match against those therapy designations that are available. In one embodiment of the invention, if an exact match exists, the therapy designation that matches is considered as an option to be selected as the best alternative therapy designation. Once considered as an option to be selected, a therapy designation is evaluated against other rules (described below). For example, therapy designation 220 includes the dose 234 of 10 mg. Because a therapy designation 236 includes a strength of 10 mg, which is usable to achieve a dose of 10 mg, the therapy designation 236 would be considered as an option to be selected as an equivalent therapy designation and would be evaluated against other rules of the rules database 216.

In a further embodiment of the present invention, pursuant to the dosage rules 232, strengths of therapy designations 228 are evaluated against divisibility and multiplication rules to identify an equivalent therapy designation and/or acceptable alternative therapy designations. Strengths of therapy designations might be evaluated against divisibility and multiplication rules even if one of the therapy designations includes a strength that provides an exact match to the extracted dose because the therapy designation that includes an exact match might not qualify as an equivalent therapy designation based on other applicable rules. When a therapy includes administration of a medication it might be possible to either divide a medication unit (e.g., divide a tablet) or administer multiple medication units (e.g., administer more than one tablet) to achieve a prescribed dosage. As such, in one embodiment the dosage rules 232 include multiplication rules 235a and divisibility rules 235b, which might vary depending on whether the medication unit is in a solid form or a liquid form. Pursuant to an embodiment of the present invention, whole numbers of medication units are preferred over fractional medication units. Furthermore, an exemplary multiplication rule 235a, in accordance with an embodiment of the present invention, provides that only therapy designations that require administration of three (3) or fewer medication units to achieve a dosage (e.g., dose 234) will be evaluated as an equivalent therapy designation and that only therapy designations that require administration of five (5) or fewer medication units to achieve a dosage will be evaluated as an acceptable alternative therapy designation. As such, a dosage rule might provide that any therapy designation that requires administration of six (6) or more medication units to achieve a dosage will not be considered as either a best alternative therapy designation or an acceptable alternative therapy designation. An exemplary divisibility rule 235b in accordance with an embodiment of the present invention states that only alternative therapy designations that require either whole number solid medication units or division of a medication unit into portions that are equal to one-half to achieve a desired dosage will be evaluated as an equivalent therapy designation. Furthermore, a divisibility rule 235b might further provide that only alternative therapy designations that require either whole number solid medication units or division of a medication unit into portions that are equal to one-fourth, one-third, one-half, two-thirds, and three-fourths to achieve a desired dosage will be evaluated as acceptable alternative therapy designations. Another exemplary divisibility rule in accordance with an embodiment of the present invention states that only alternative therapy designations that require an exact ratio of a nonsolid medication unit will be considered as an equivalent therapy designation. For example, if a therapy designation in a first treatment venue specifies 5 mg/mL, an alternative therapy designation that specifies 50 mg/10 mL or 100 mg/20 mL would be evaluated as an equivalent therapy designation. A further exemplary divisibility rule 235b states that only alternative therapy designations that require a ratio of a nonsolid medication unit that is between 1:10 and 10:1 will be considered as acceptable alternative therapy designations.

A therapy designation 222a in a first treatment venue might specify a combination drug that includes a specific ratio of multiple drugs, each of which includes a respective strength (e.g., Augmentin® includes amoxicillin and clavulanate potassium). In an embodiment of the present invention, a dosage rule dictates that if the therapy designation 222a in the first treatment venue specifies a combination drug, an equivalent therapy designation is only selected if the therapy designation 222a in the first treatment venue specifies strength information. For example, if the therapy designation 222a in the first treatment venue indicates “acetaminophen with codeine, 500 mg,” an equivalent therapy designation is not selected because no strength information is provided (i.e., only dosage information is provided). Instead, a user might interact with the GUI 222 to input the required details based on the generic chemical names of the different drugs that make up the combination drug. On the other had, if the therapy designation 222a in the first treatment venue indicates “300 mg Drug A—30 mg Drug B, 2 tabs,” an equivalent therapy designation can be selected because strength information is provided, in which case the original ratio is maintained.

In a further embodiment, the rules database 216 includes form-compatibility rules 238, which are usable to select an equivalent therapy designation based on form-similarity consideration, e.g., whether a form specified by an alternative therapy designation is the same as, or deemed equivalent to, the form specified by the therapy designation in the first treatment venue. Examples of forms include caplet, tablet, capsule, cream, ointment, chewable, liquid, injection solution, and spray solution. In one embodiment, if the availability rules 230 (described previously) are not met, the therapy reconciler 212 extracts a form (e.g., form 240) from the therapy designation that is used to identify the therapy in the first treatment venue. That is, the original drug form that is specified by the therapy designation in the first treatment venue is favored. In a further embodiment, form-compatibility rules 238 specify a set of forms that are equivalent to the extracted form. For example, if an extracted form includes tablets, then form-compatibility rules 238 might specify that caplets are an equivalent form. In a further embodiment, special characteristics of a form of a therapy are also taken into account when evaluating alternative therapy designations. For example, a form of a medication might have special release characteristics (e.g., extended release), which should be taken into account when determining if another form is acceptable. For example, a form-compatibility rule 238 might dictate that a nonspecial-characteristic tab is not compatible to be used when an extended release tab is specified in the first treatment venue. In further embodiments, form-compatibility rules are based on the divisibility of a medication unit to achieve a desired dosage. For example, because gel caplets might not be easily divided to achieve a dosage, gel caplets might not be included as a compatible form when a desired dosage requires a fractional gel caplet.

In a further embodiment, the rules database 216 includes naming-convention rules 242, which are usable to select an equivalent therapy designation based on whether a name specified by an alternative therapy designation is within a same naming convention as the therapy designation in the first treatment venue. Examples of naming conventions that apply to administration of a medication include generic names, generic-product names, brand names, and brand-product names. A generic name includes only the name of a generic chemical substance, e.g., acetaminophen. A generic-product name includes a name that is specific to the generic chemical substance together with a strength of a medication unit. For example, both “extra-strength acetaminophen PM” and “acetaminophen 500 mg” might describe acetaminophen that has a strength of 500 mg/medication unit. A brand name only includes a name that identifies a specific manufacturer's version of a generic chemical substance, e.g., Tylenol® refers to a specific manufacturer's version of acetaminophen. A brand-product name includes a name that identifies a manufacturer's version of a generic chemical substance together with a strength of the medication unit, e.g., Tylenol PM® refers to a specific manufacturer's version of acetaminophen that has a strength of 500 mg/medication unit. In FIG. 2, the therapy designation 220 includes only a generic name “oxycodone” together with instructions on how the generic chemical substance should be administered. For illustrative purposes in FIG. 2, commas are used to separate the naming convention from the rest of the order or prescription details. As such, because in therapy designation 220 “oxycodone” is separated by a comma from “10 mg, tab, PRN,” only the term oxycodone is considered in determining what naming convention is applicable. On the other hand, therapy designation 236 is a brand-product name because “OxyNorm 10 mg capsule” by itself denotes a specific manufacturer's version of oxycodone that has a strength of 10 mg/capsule. In contrast, therapy designation 244 is only a brand name, which only denotes a specific manufacturer's version of oxycodone and does not provide additional strength information.

In an embodiment of the present invention, if the availability rules 230 (described previously) are not met, the therapy reconciler 212 determines if the therapy designation in the first treatment venue includes a generic name, a generic-product name, a brand name, or a brand-product name. For example, therapy designation 220 includes a generic name (oxycodone), with additional details that describe total dose, form, and frequency. In a further embodiment, the naming-convention rules 242 provide that if the therapy designation in the first treatment venue includes either a generic name or a generic-product name, then therapy designations in the second treatment venue that include either a generic-product or only the generic name will be evaluated as best alternative therapy designations and those that include a brand name or a brand-product are not acceptable as alternative therapy designations. Furthermore, as between generic-product names and generic names, generic-product names are favored, provided they satisfy the therapy requirements. In another embodiment, the naming-convention rules 242 provide that if the therapy designation in the first treatment venue includes either a brand name or a brand-product name, then therapy designations in the second treatment venue that include either a brand-product or only the brand name will be evaluated as best alternative therapy designations and those that include a generic-product name are not acceptable as alternative therapy designations. Furthermore, as between brand-product names and brand names, brand-product names are favored, provided they satisfy the therapy requirements. If the therapy designation in the first treatment venue includes either a brand name or a brand-product name, and no other best alternative therapy designation is identified, then the therapy reconciler 212 defaults to the generic name to identify the therapy in the second treatment venue. As such, in one embodiment neither a brand name (e.g., Tylenol®) nor a brand-product name (e.g., Tylenol PM®) will be considered as a best alternative or an acceptable alternative if a generic name (e.g., acetaminophen) or a generic-product (e.g., acetaminophen PM) is specified in the first treatment venue. However, if a brand name or a brand-product name is used in the first treatment venue to describe a therapy, then a generic name will be considered as a default to identify the therapy in the second treatment venue if no other brand name or brand-product name is available as an acceptable alternative therapy designation. In this case, a generic name will be considered because the proper generic chemical name is specified (i.e., by the generic name) and the additional details (e.g., dose) can be supplied by a user (as described below).

Referring now to FIGS. 3-9 additional embodiments of the present invention will be now be described in more detail. FIGS. 3-9 each depict an exemplary screenshot that might be displayed on a monitor of the user device 218. Referring to FIG. 3, screenshot 300 includes a portion 310 for displaying therapy designations that identify therapies, which were administered to a patient 305 prior to discharge (e.g., prior to discharge from a healthcare facility). In accordance with embodiments of the present invention, “therapies prior to discharge” are therapies that are administered in a first treatment venue. For example, screenshot 300 depicts that therapy designation 320, which indicates “oxycodone, 10 mg, PO, Q6HR, PRN for pain,” was being administered to the patient 305 prior to discharge. Moreover, because a continuation circle 325 is marked, screen shot 300 indicates that the therapy described by the therapy designation 320 should continue to be administered to the patient 305 after the patient is discharged. However, no order has been created under portion 315, which is for displaying therapy designations that describe therapies that will be administered to the patient 305 after the patient is discharged. This is also indicated by button 330, which indicates that one (1) order needs to be reconciled. Pursuant to embodiments of the present invention, the therapy designation 320 is submitted to the therapy reconciler 212, which selects, based on rules (described previously) from the rules database 216, equivalent therapy designations from the alternative therapy designations stored in the therapy database 214.

FIG. 4 depicts a screenshot 400 after the therapy reconciler 212 has selected an equivalent therapy designation 350 from the alternative therapy designations 228 in the therapy database 214. By applying availability rules 230, dosage rules 232, form-compatibility rules 238, and naming-convention rules 242, the therapy reconciler 212 determined that “oxycodone 5 mg oral tablet, 10 mg, 2 ea, PO, Q6HR . . . ” was the equivalent therapy designation 350. For example, by applying the availability rules 230 it can be determined that no exact match to therapy designation 320 exists in the list of alternative therapy designations 228. Moreover, according to the naming-convention rules 242, because therapy designation 320 includes a generic name, none of the brand names or brand-product names are eligible to be evaluated as either best or acceptable alternative therapy designations, i.e., all of the brand names and brand-product names are nonmatches. Furthermore, according to the form-compatibility rule 238, the original form (i.e., tab) is preferred to other forms and no specific form-compatibility rule has specified that an oral solution or a solution injection is equivalent to tablet. By applying the dosage rules 232, which indicate that if no exact dosage match is found, whole numbers of medication units are preferred to fractional numbers of medication units, the therapy reconciler 212 determines that a 5 mg tab is favored over 15 mg tab or 30 mg tab. As such, the therapy reconciler 212 selects the equivalent therapy designation 350 that, based on rules 230, 232, 238, and 242, is most similar to the therapy designation 320 that describes the therapy in the first treatment venue.

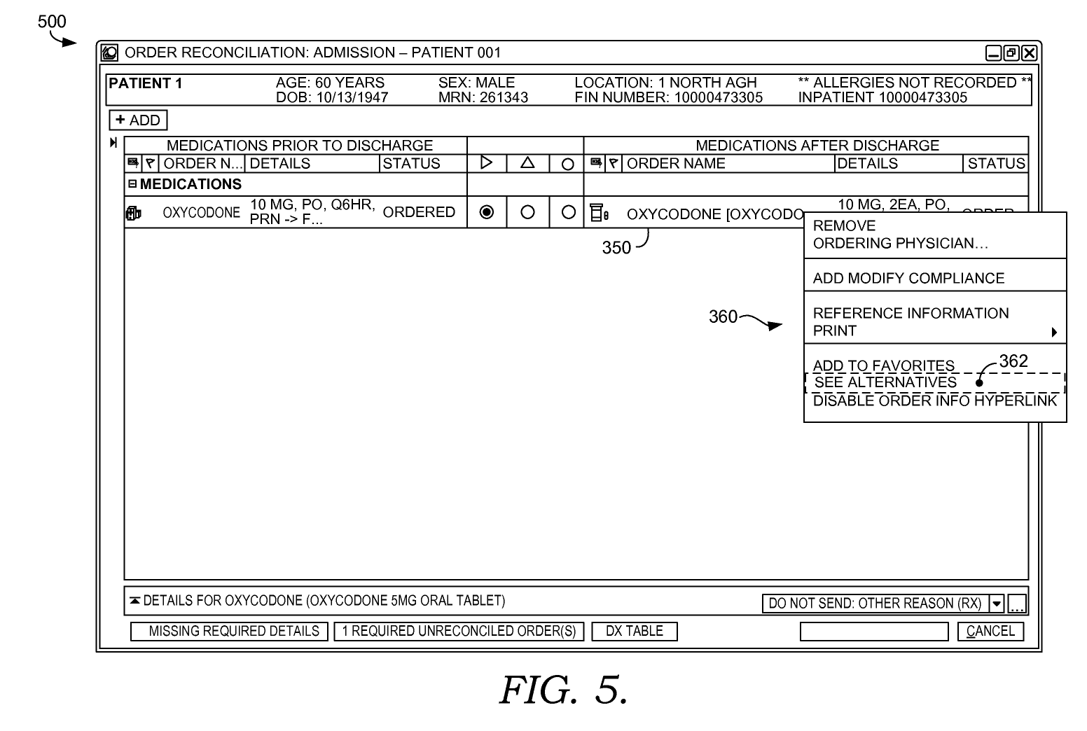

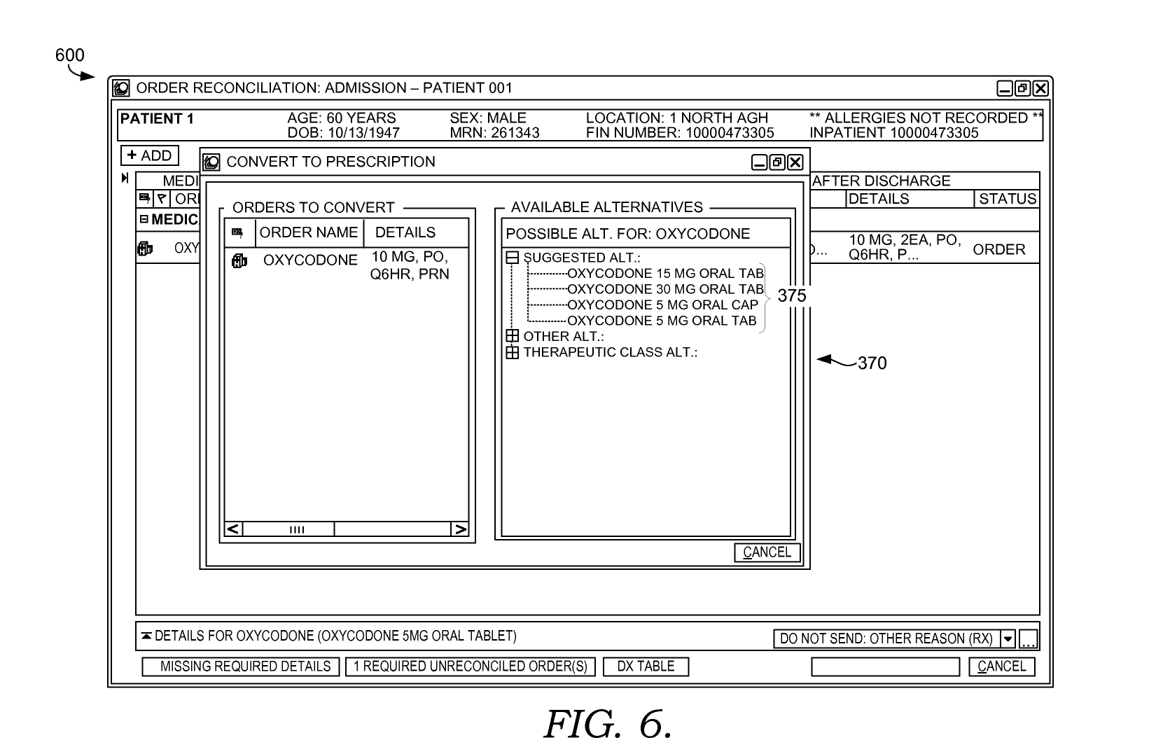

In a further embodiment, screenshot 400 includes button 355, which allows a user to accept the equivalent therapy designation 350 that was selected by the therapy reconciler 212. For example, by inputting button 355 an order or a prescription might be generated to facilitate administration of the therapy to the patient in the second treatment venue. However, if the user instead wants to view the alternative therapy designations that were deemed by the therapy reconciler 212 to be acceptable alternative therapy designations, embodiments of the present invention allow the user to view those as well. Referring to FIG. 5, which depicts a screenshot 500, instead of inputting button 355, the user might perform a series of inputs that invokes an overlay window 360. For example, the user might right-click a mouse while a cursor is hovered over the equivalent therapy designation 350. Overlay window 360 presents a set of options that are selectable by the user. For example, option 362, which is indicated as highlighted, enables a user to “see alternatives” that include acceptable alternative therapy designations. Turning to FIG. 6 a screenshot 600 is presented of a view that might be displayed when the user selects option 362 (in FIG. 5). For example, FIG. 6 depicts an overlay window 370, which presents a set of therapy designations 375 that were deemed by the therapy reconciler 212 to be acceptable alternative therapy designations, based on rules 230, 232, 238, and 242. As previously indicated, naming-convention rule 242 provides that because therapy designation 320 is a generic name, each of the therapy designations of the set 375 is an acceptable alternative therapy designation because each is a generic-product name. Furthermore, if form-compatibility rules 238 provide that a tablet is equivalent to a caplet, then each of the therapy designations of the set 375 are acceptable alternative therapy designations because each includes either a tablet or a caplet. By applying the dosage rules 232, which include the divisibility rules 235b and multiplication rules 235a, the therapy reconciler 212 determines that each of the therapy designations of the set 375 is an acceptable alternative therapy designation because each describes a product that either can be multiplied by five (5) or less to achieve a dose of 10 mg or can be divided by one-third or two-thirds to achieve a dose of 10 mg. As such, even though all of the therapy designations of the set 375 are not best alternative therapy designations, each of the therapy designations of the set 375 is an acceptable alternative therapy designation.

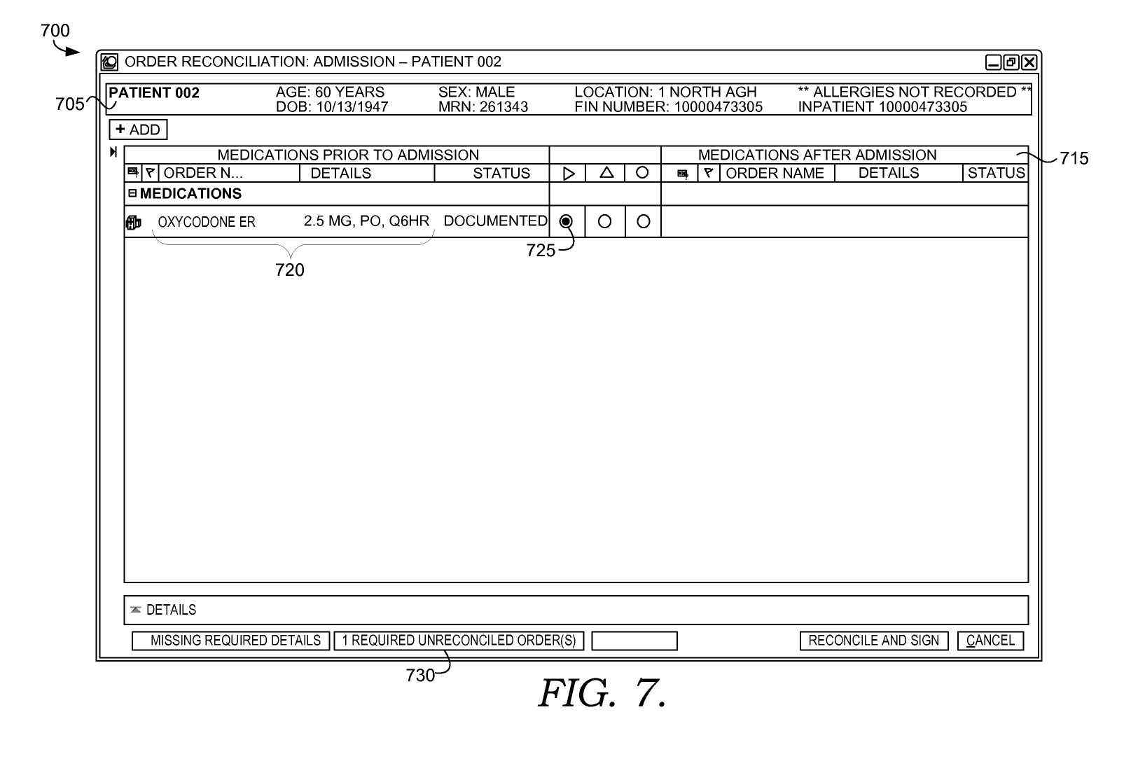

FIGS. 7-9 depict a series of screenshots that might be displayed on the user device 218 when the therapy reconciler 212 does not select an equivalent therapy designation. For example, FIG. 7 depicts a screenshot 700, which includes a therapy designation 720 of a therapy in a first treatment venue, which is prior to admission of a patient (e.g., admission of Patient 002 to a healthcare facility). Accordingly, whatever facility into which the patient is being admitted constitutes a subsequent treatment venue. Screenshot 700 might be displayed on user device 218, for example, during a procedure that is required to admit a patient into a healthcare facility. Pursuant to therapy designation 720, Patient 002 is following a therapy regimen that includes “oxycodone er, 2.5 mg, PO, Q6HR,” when the patient is admitted. According to screenshot 700, a user has determined that Patient 002 will continue to receive this therapy after admission, as indicated by a selection of continuation circle 725. However, no order has been created under portion 715, which is for displaying therapy designations that describe therapies that will be administered to the patient 705 after the patient is admitted. This is also indicated by button 730, which indicates that one (1) order needs to be reconciled. Pursuant to embodiments of the present invention, the therapy designation 720 is submitted to the therapy reconciler 212, which attempts to select, based on rules (described previously) from the rules database 216, an equivalent therapy designation from the alternative therapy designations stored in the therapy database 214. However, because therapy designation 720 specifies “ER” (i.e., extended release), the therapy reconciler is unable to select from therapy designations 228 an equivalent therapy designation that provides a required form.

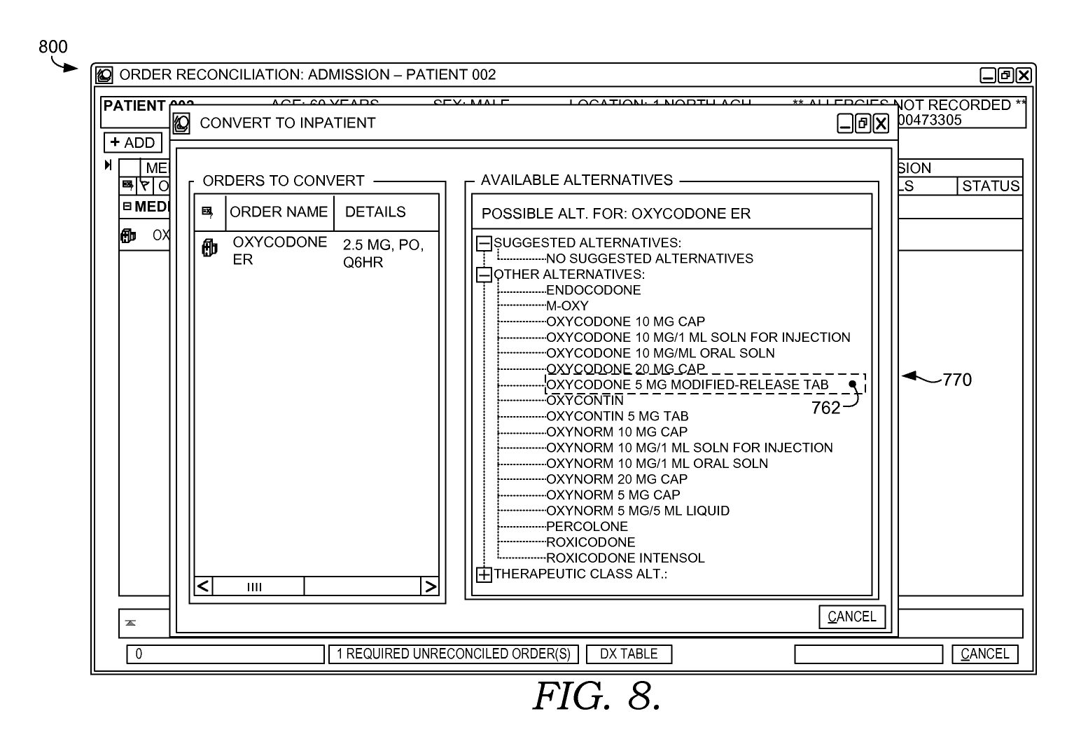

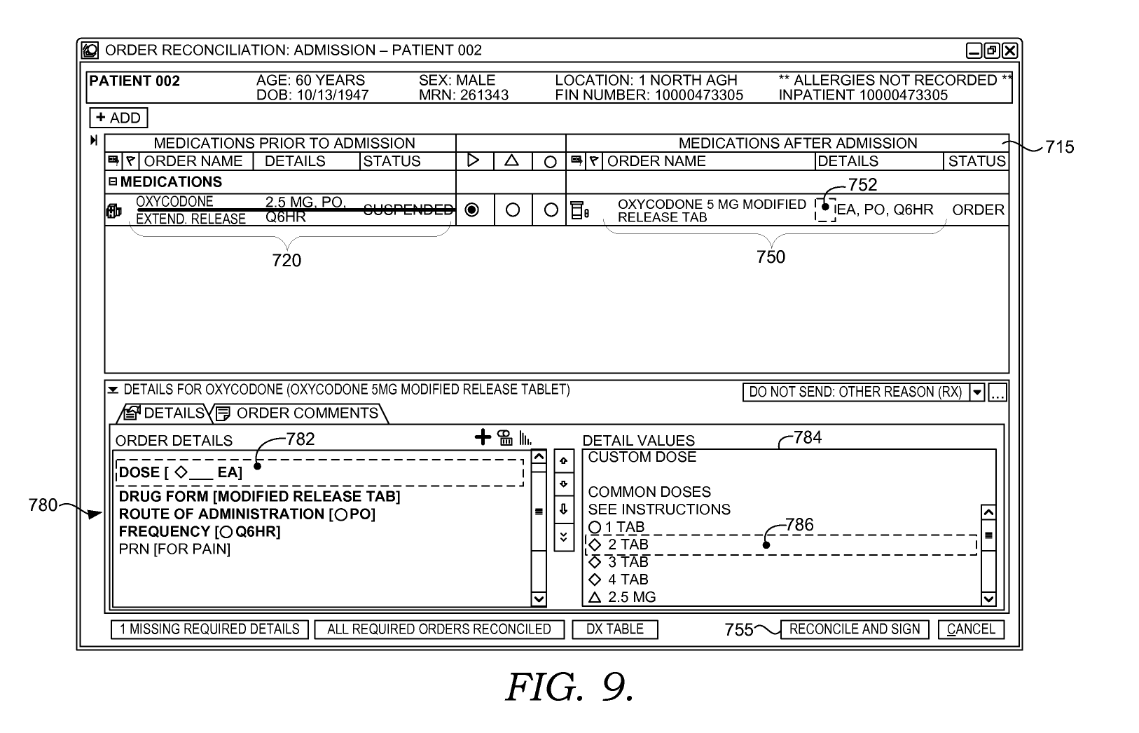

In an embodiment of the invention, when the therapy reconciler 212 is not able to select an equivalent therapy designation, possible alternative therapy designations are presented for selection by a user. Referring to FIG. 8, a screenshot 800 is shown that includes an overlay window 770. The overlay window 770 presents therapy designations that are stored in the therapy database 214. As such, a user is able to view the alternative therapy designations that are available to describe the therapy in the second treatment venue, so that the user can make an appropriate selection. As indicated by a highlight box 762, the user has selected “oxycodone 5 mg modified-release tab” as an alternative therapy designation. Turning to FIG. 9, in a further embodiment of the present invention, the alternative therapy designation that is selected (see FIG. 8) is populated into a portion 715 that displays “Medications After Admission.” FIG. 9 shows that therapy designation 750 has been populated to include “oxycodone 5 mg modified-release tab.” Furthermore, the therapy designation 720 has been lined-through to indicate that a new alternative therapy designation is being used in the second treatment venue. Because therapy designation 750 was selected by the user, additional details are required to be completed in the details portion 780. For example, as indicated by a highlight box 782, a number of medication units that are to be administered to achieve a desired dose must be input. To input a number of medication units, the user can select from options provided in portion 784 of the details portion. For example, highlight box 786 indicates that a user has selected “2 Tab,” which the invention populates into field 752. Button 755 allows a user to accept the alternative therapy designation 750 that was selected. For example, by inputting button 755 an order or a prescription might be generated to facilitate administration of the therapy to the patient in the second treatment venue.

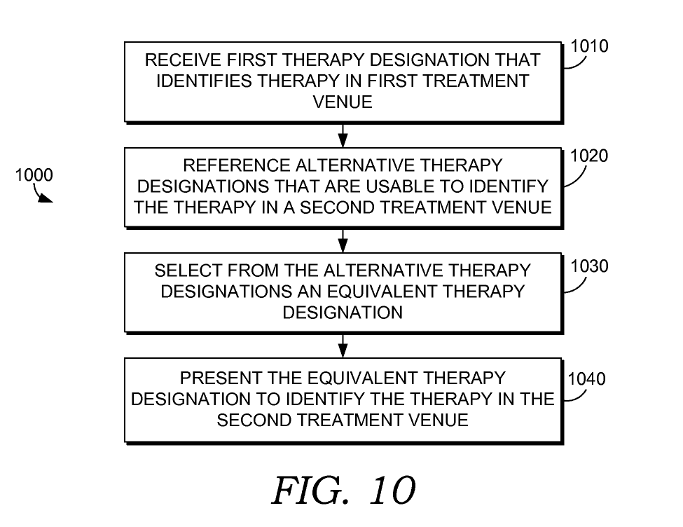

As depicted by a flow diagram in FIG. 10, in a further embodiment, the present invention is directed to a computer-implemented method 1000, which is executed with one or more of a server and a computer storage medium, of selecting a therapy designation that is usable to identify a therapy when the therapy is implemented in a treatment venue. The computer-implemented method 1000 includes at step 1010 receiving a first therapy designation that identifies the therapy (e.g., administration of a medication) when the therapy is implemented in a first treatment venue (e.g., inpatient facility or outpatient environment). Step 1020 includes referencing in the computer storage medium (e.g., therapy database) one or more alternative therapy designations (e.g., alternative therapy designations stored in the therapy database) that are usable to identify the therapy when the therapy is implemented in a second treatment venue. At step 1030 the server selects from the one or more alternative therapy designations an equivalent therapy designation that, based on one or more rules, is most similar to the first therapy designation. Step 1040 includes presenting the equivalent therapy designation to be used to identify the therapy in the second treatment venue. In a further embodiment, the method 1000 described in FIG. 10 is stored on a computer storage medium as a set of computer executable instructions that, when executed, cause a computing device to perform the method 1000.

In a further embodiment, the present invention is directed to a system for selecting a therapy designation that is usable to identify a therapy when the therapy is implemented in a treatment venue. The system includes a receiving component (e.g., user device 218) that is usable to receive a first therapy designation, which identifies the therapy when the therapy is implemented in a first treatment venue. The system also includes a therapy reconciler that references in a computer storage medium one or more alternative therapy designations that are usable to identify the therapy when the therapy is implemented in a second treatment venue. Moreover, the system includes a rules engine that provides the therapy reconciler with one or more rules, which are usable to select from the one or more alternative therapy designations an equivalent therapy designation that is similar to the first therapy designation. Furthermore, the system includes a presentation component (e.g., user device 218) that presents the equivalent therapy designation to be used to identify the therapy in the second treatment venue.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A computer-implemented method, which is executed with one or more of a server and a computer storage medium, of selecting a therapy designation that is usable to identify a therapy when the therapy is implemented in a treatment venue, the method comprising:
receiving a first therapy designation that identifies the therapy when the therapy is implemented in a first treatment venue;
referencing in the computer storage medium one or more alternative therapy designations that are usable to identify the therapy when the therapy is implemented in a second treatment venue;
selecting by the server, from the one or more alternative therapy designations, an equivalent therapy designation that, based on one or more rules, is most similar to the first therapy designation; and
presenting the equivalent therapy designation to be used to identify the therapy in the second treatment venue.

2. The computer-implemented method of claim 1, wherein the therapy includes administration of a dosage of medication that is achievable by administering a number of medication units that have a medication-unit strength.

3. The computer-implemented method of claim 2, wherein each of the one or more alternative therapy designations identify a respective medication-unit strength.

4. The computer-implemented method of claim 2,
wherein at least one of the one or more rules is usable to select the equivalent therapy designation based on availability in the second treatment venue of the medication in a version that is specified by the first therapy designation, and
wherein a version of a medication includes one or more of a medication strength and a medication dosage.

5. The computer-implemented method of claim 1, wherein at least one of the one or more rules is usable to select the equivalent therapy designation based on dosage-achievability considerations, which are usable to evaluate whether a first dosage specified by the first therapy designation is achievable using respective strengths specified by each of the one or more alternative therapy designations.

6. The computer-implemented method of claim 1, wherein one of the one or more rules is usable to select the equivalent therapy designation based on form-similarity considerations, which specify an alternative medication form that is equivalent to a medication form specified by the first therapy designation.

7. The computer-implemented method of claim 1, wherein one of the one or more rules is usable to select the equivalent therapy designation based on whether a name specified by an alternative therapy designation is within a same naming convention as the therapy designation in the first treatment venue

8. The computer-implemented method of claim 1 further comprising:
receiving a request to present the one or more alternative therapy designations;
presenting the one or more alternative therapy designations;
receiving a selection of one of the one or more alternative therapy designations; and
presenting the one of the one or more alternative therapy designations to be used to identify the therapy in the second treatment venue.

9. A computer storage medium having stored thereon computer-executable instructions that, when executed, cause a computing device to perform a method of selecting a therapy designation that is usable to identify a therapy when the therapy is implemented in a treatment venue, the method comprising:
receiving a first therapy designation that identifies the therapy when the therapy is implemented in a first treatment venue;
referencing one or more alternative therapy designations that are usable to identify the therapy when the therapy is implemented in a second treatment venue;
selecting from the one or more alternative therapy designations an equivalent therapy designation that, based on one or more rules, is most similar to the first therapy designation; and
presenting the equivalent therapy designation to be used to identify the therapy in the second treatment venue.

10. The computer storage medium of claim 9,
wherein the first treatment venue includes an outpatient treatment venue, and
wherein the second treatment venue includes an inpatient treatment venue.

11. The computer storage medium of claim 9,
wherein the first treatment venue includes an inpatient treatment venue, and
wherein the second treatment venue includes an outpatient treatment venue.

12. The computer storage medium of claim 9,
wherein when the first therapy designation includes a medication dosage that is to be administered as part of the therapy, a dosage-achievability rule is used to evaluate the one or more alternative therapy designations;
wherein pursuant to the dosage-achievability rule, each of the one or more alternative therapy designations that includes a respective medication strength that is usable to achieve the medication dosage is a candidate to be selected as the equivalent therapy designation; and
wherein when none of the one or more alternative therapy designations specify a respective medication strength that is usable to achieve the medication dosage, all of the one or more alternative therapy designations are presented as options that are selectable by a user to identify the therapy in the second treatment venue.

13. The computer storage medium of claim 12, wherein when the one or more alternative therapy designations include both:
a first set of alternative therapy designations, each of which include a respective strength that requires a whole number of a medication unit to achieve a dosage of the therapy designation, and
a second set of alternative therapy designations, each of which includes a respective strength that requires a fractional number of a medication unit to achieve the dosage of the therapy designation, and
pursuant to the dosage-achievability rule, the alternative therapy designations of the first set are favored to the alternative therapy designations of the second set.

14. The computer storage medium of claim 12, wherein pursuant to the dosage-achievability rule, when an alternative therapy designation prescribes a strength that requires a whole number of medication units that is greater than five, the alternative therapy designation is not considered as a candidate to be selected as the equivalent therapy designation.

15. The computer storage medium of claim 12, wherein pursuant to the dosage-achievability rule, when an alternative therapy designation prescribes a strength that requires a fractional number of medication units that is not equal to one-half, the alternative therapy designation is not considered as a candidate to be selected as the equivalent therapy designation.

16. The computer storage medium of claim 9,
wherein when the first therapy designation specifies a medication form, a form-compatibility rule is used to evaluate the one or more alternative therapy designations; and
wherein the form-compatibility rule specifies alternative medication forms that are equivalent to the medication form.

17. The computer storage medium of claim 9,
wherein when the first therapy designation includes a brand name of a medication, a brand-specificity rule is used to evaluate the one or more alternative therapy designations;
wherein pursuant to the brand-specificity rule, each of the one or more alternative therapy designations that specify a product of the brand name is a candidate to be selected as the equivalent therapy designation; and
wherein when none of the one or more alternative therapy designations specify the brand name, the one or more alternative therapy designations are presented as options that are selectable by a user to identify the therapy in the second treatment venue.

18. A system for selecting a therapy designation that is usable to identify a therapy when the therapy is implemented in a treatment venue, the system comprising:
a receiving component that is usable to receive a first therapy designation, which identifies the therapy when the therapy is implemented in a first treatment venue;
a therapy reconciler that references in a computer storage medium one or more alternative therapy designations that are usable to identify the therapy when the therapy is implemented in a second treatment venue;
a rules engine that provides the therapy reconciler with one or more rules, which are usable to select from the one or more alternative therapy designations an equivalent therapy designation that is similar to the first therapy designation; and
a presentation component that presents the equivalent therapy designation to be used to identify the therapy in the second treatment venue.

19. The system of claim 18, wherein the one or more rules include a dosage-achievability rule, a form-compatibility rule, and a brand-specificity rule.

20. The system of claim 18, wherein the receiving component includes a graphical user interface and wherein the graphical user interface includes:
a medication-input portion that allows a user to input a first therapy designation;
a therapy-reconciliation-results portion that is usable to display the matching therapy designation, which is selected based on the one or more rules; and
a details-entry portion that allows a user to input instructions that describe administration of the matching therapy designation.
